(19) United States
(12) Patent Application Publication
(10) Pub. No.: US 2014/0168371 A1
(43) Pub. Date: Jun. 19, 2014

(54) IMAGE PROCESSING APPARATUS AND IMAGE REFOCUSING METHOD

(71) Applicant: INDUSTRIAL TECHNOLOGY RESEARCH INSTITUTE, Hsinchu (TW)

(72) Inventor: Chuan-Chung Chang, Hsinchu County (TW)

(73) Assignee: INDUSTRIAL TECHNOLOGY RESEARCH INSTITUTE

(21) Appl. No.: 13/903,932

(22) Filed: May 28, 2013

(30) Foreign Application Priority Data
Dec. 19, 2012 (TW) 101148231

(51) Int. Cl. H04N 13/00

(52) U.S. Cl. CPC H04N 13/0007
USPC 348/46

(57) ABSTRACT

An image refocusing method for use in an image processing apparatus is provided. The image processing apparatus has an image capturing unit and an image processing unit. The method has the following steps of: receiving lights of a scene via the image capturing unit to output a raw image having information of different views; rearranging the raw image from the image sensor to obtain multiple different view sub-images; performing a refocusing process to at least one specific view sub-image of the different view sub-images corresponding to a specific view to generate multiple refocused view images, wherein a first focusing position of the refocused view images is different from a second focusing position of the at least one specific view sub-image; and outputting the refocused view images to a stereoscopic display device.

### CROSS REFERENCE TO RELATED APPLICATIONS

This application claims priority of Taiwan Patent Application No. 101148231, filed on Dec. 19, 2012, the entirety of which is incorporated by reference herein.

### BACKGROUND OF THE DISCLOSURE

1. Technical Field

The present disclosure relates to image processing, and in particular, relates to an image processing apparatus and image refocusing method for performing an image refocusing process to different view images.

2. Description of the Related Art

In recent years, an image capturing module having multiple functions has become a highly noticed equipment for technology development, Also, interest in “Light Field” technology has increased among the potential image processing technologies. A plenoptic camera, which is implemented by using light field technology, may be capable of capturing stereoscopic images and performing all-in-focus and digital focusing processes. An image can be implemented by performing the all-in-focus processing in the plenoptic camera. In addition, the focusing position of output images can be alternated freely by performing the digital focusing process in the plenoptic camera. Also, the plenoptic camera may rearrange the captured images to generate images of different views. Accordingly, the plenoptic camera is a device to obtain images of different views effectively when the plenoptic camera is being used for stereoscopic image capturing.

### SUMMARY

A detailed description is given in the following embodiments with reference to the accompanying drawings.

In an exemplary embodiment, an image processing apparatus is provided. The image processing apparatus comprises: an image capturing unit, comprising: a primary lens; a lens array comprising multiple sub-lenses arranged in a direction perpendicular to a light axis of the primary lens; and an image sensor configured to receive lights of a scene passing through the primary lens and the lens array, and output a raw image having information of different views; and an image processing unit configured to rearrange the raw image from the image sensor to obtain multiple different view sub-images, and perform a refocusing process to at least one specific view sub-image of the different view sub-images corresponding to a specific view to generate multiple refocused view images, wherein a first focusing position of the refocused view images is different from a second focusing position of the at least one specific view sub-image. The processing unit further outputs the refocused view images to a stereoscopic display device.

In another exemplary embodiment, an image refocusing method for use in an image processing apparatus is provided. The image processing apparatus comprises an image capturing unit and an image processing unit. The method comprises the following steps of: receiving lights of a scene via the image capturing unit to output a raw image having information of different views; rearranging the raw image from the image sensor to obtain multiple different view sub-images; performing a refocusing process to at least one specific view sub-image of the different view sub-images corresponding to a specific view to generate multiple refocused view images, wherein a first focusing position of the refocused view images is different from a second focusing position of the at least one specific view sub-image; and outputting the refocused view images to a stereoscopic display device.

### BRIEF DESCRIPTION OF THE DRAWINGS

The present disclosure can be more fully understood by reading the subsequent detailed description and examples with references made to the accompanying drawings, wherein:

FIG. 1A is a schematic diagram of an image processing apparatus 100 according to an embodiment of the disclosure;

FIG. 1B is a schematic diagram of an image capturing unit 110 according to an embodiment of the disclosure;

FIGS. 1C˜1E are diagrams illustrating the procedure for obtaining different view sub-images from the raw image according to an embodiment of the disclosure;

FIGS. 2A and 2B are diagrams illustrating sampling images by using the image capturing unit 110 according to an embodiment of the disclosure;

FIGS. 3A˜3E are diagrams illustrating the operations of a digital focusing process in the image processing unit 120 according to an embodiment of the disclosure;

FIGS. 4A˜4C are diagrams illustrating stereoscopic displaying of the image processing unit 120 according to the first embodiment of the disclosure;

FIG. 5 is a diagram illustrating the image enlarging process of the raw image having information from different views according to the second embodiment of the disclosure;

FIGS. 6A˜6C are diagrams illustrating stereoscopic displaying of the image processing unit according to the third embodiment of the disclosure; and

FIG. 7 is a flow chart illustrating the image refocusing method according to an embodiment of the disclosure.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

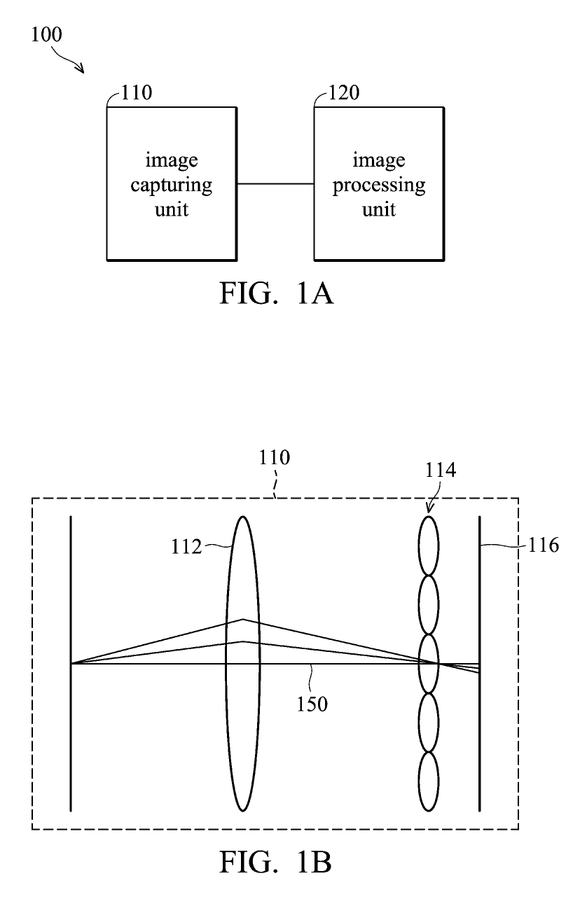

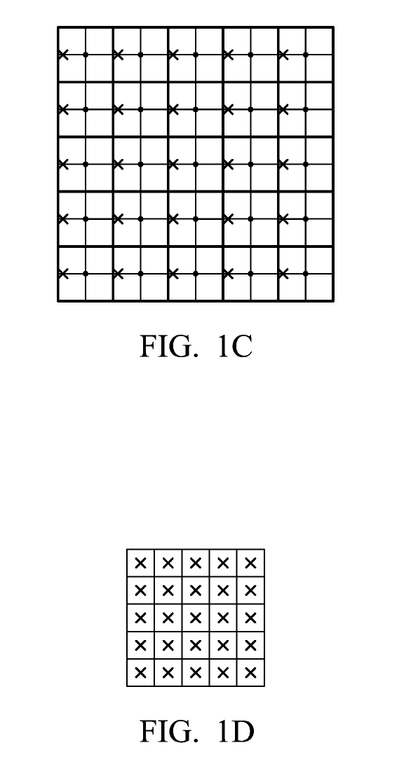

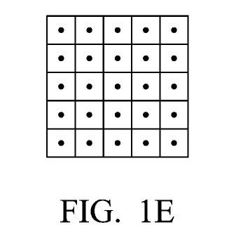

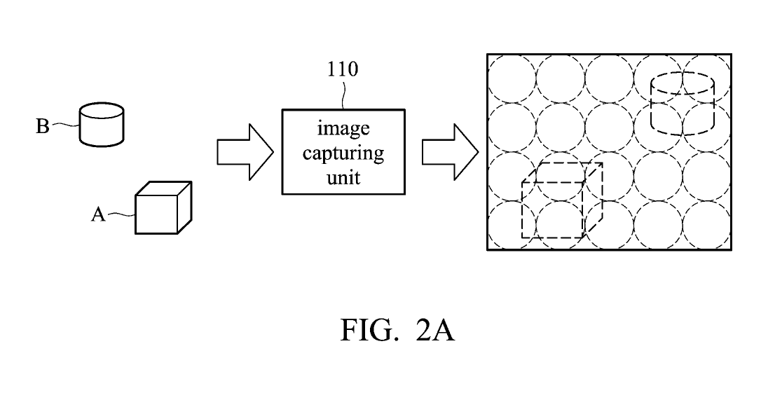

FIG. 1A is a schematic diagram of an image processing apparatus 100 according to an embodiment of the disclosure. FIG. 1B is a schematic diagram of an image capturing unit 110 according to an embodiment of the disclosure. The image processing apparatus 100 may comprise an image processing unit 120 and an image processing unit 120. In an embodiment, the image capturing unit 110 is configured to retrieve raw images having information from different views simultaneously, and the captured raw images may have a first object and a second object located at different depths. The image processing unit 120 is configured to rearrange the raw images from the image capturing unit 110 to obtain multiple different-view sub-images. Then, the image processing unit 120 may perform a refocusing process to at least one specific view sub-image of the different-view sub-images, thereby generating a refocused view image, and then output the refocused view image to a stereoscopic display device. The details of the aforementioned image processing procedure will be described later.

For example, the image capturing unit 110 may be a plenoptic camera, which comprises a primary lens 112, a lens array 114, and an image sensor 116. The lens array 114 may comprises multiple sub-lenses (e.g. M*N sub-lens), which are arranged in a direction perpendicular to a light axis 150 of the primary lens 112, as illustrated in FIG. 1B. The image sensor 116 may comprise a plurality of light-sensitive pixels (e.g. m*n light-sensitive pixels, wherein the amount of the sub-lenses may be different from that of the light-sensitive pixels). Alternatively, the image sensor 116 may comprise a plurality of sub-image sensors (e.g. O*P sub-image sensors), wherein each sub-image sensor has a plurality of light-sensitive pixels, and the amount of light-sensitive pixels of each sub-image sensor may be different. There is a corresponding region of light-sensitive pixels in the image sensor 116 to receive lights passing through each sub-lens in the lens array 114. When lights from the scene to be captured pass through the primary lens 112 and the lens array 114, images captured of different views will be emitted to the image sensor 116, thereby obtaining a raw image having information from different views.

FIGS. 1C˜1E are diagrams illustrating the procedure for obtaining different view sub-images from the raw image according to an embodiment of the disclosure. Referring to FIGS. 1A˜1C, the image processing unit 120 may rearrange the raw image from the image capturing unit 110 to obtain multiple view sub-images, as illustrated in FIGS. 1D and 1E. When retrieving a specific view sub-image from the raw image in FIG. 1C, pixels in the same location of each 2×2 block can be retrieved and combined into the specific view sub-image. For example, if pixels in the “x” location of each view sub-images in FIG. 1C are retrieved, the retrieved pixels can be combined into a side view sub-image, as illustrated in FIG. 1D. If pixels in the “•” location of each view sub-images in FIG. 1C are retrieved, the retrieved pixels can be combined into a center view sub-image, as illustrated in FIG. 1E.

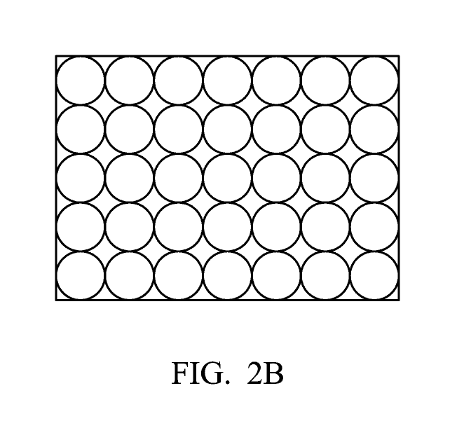

FIGS. 2A and 2B are diagrams illustrating sampling images by using the image capturing unit 110 according to an embodiment of the disclosure. Referring to FIGS. 1A, 1B and 2A, when the image capturing unit 110 is used to capture an object A and an object B in a scene and the image capturing unit 110 focuses on the object A, a raw image having information from different views can be obtained. The raw image may be the image received by the image sensor 116. The image processing unit 120 may rearrange the raw image from the image capturing unit 110, thereby obtaining a view sub-image set comprising multiple sub-images, as illustrated in FIG. 2B.

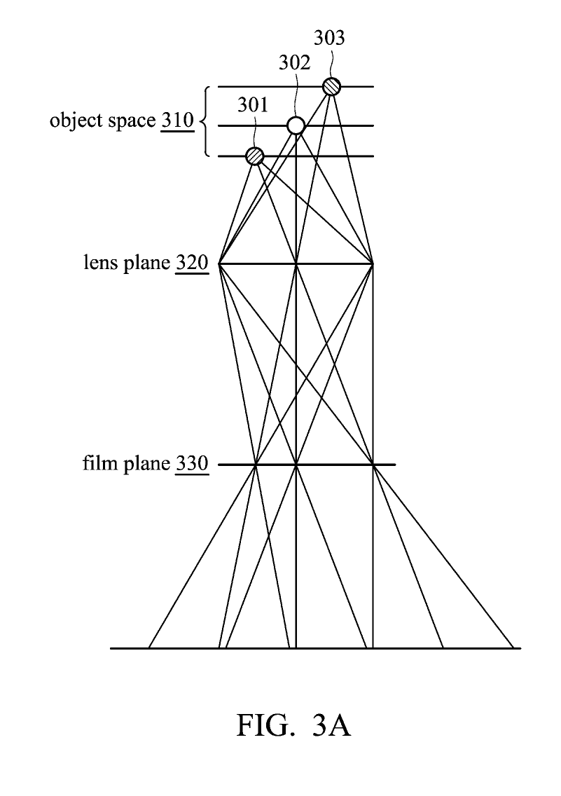

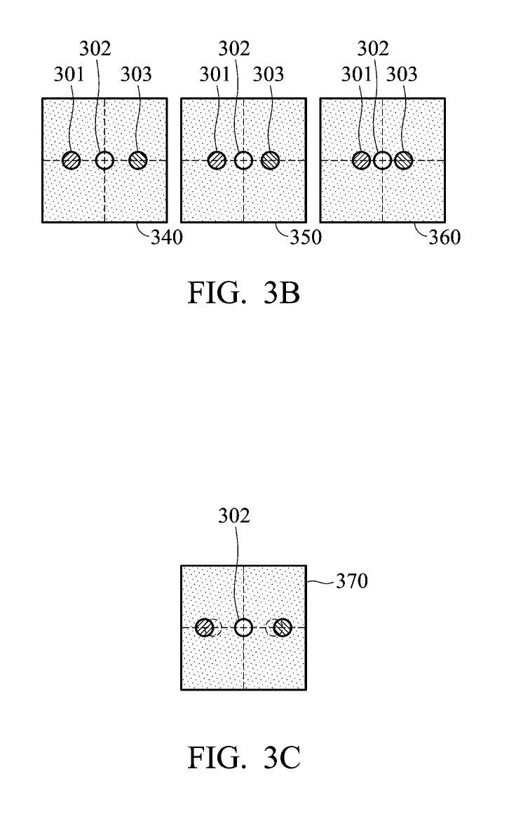

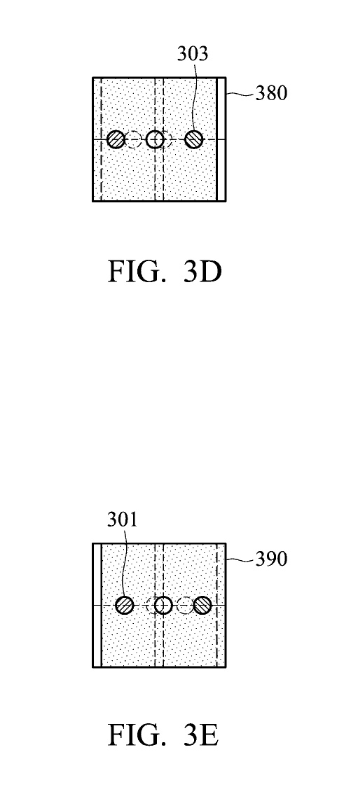

FIGS. 3A˜3E are diagrams illustrating the operations of a digital focusing process in the image processing unit 120 according to an embodiment of the disclosure. Referring to both FIGS. 1A and 3A, objects 301, 302 and 303 are located in the object space 310, and the objects 301, 302 and 303 are located at different distances in front of the image capturing unit 110. For example, lights from different views in the object space 310 may pass through the lens plane 320 and then be focused on the film plane, thereby forming an image on the film plane 330. That is, after lights from different views in the scene (i.e. object space 310) pass through the lens array 114 (located between primary lens (lens plane 320) and film plane 330), the lights may be received by the image sensor 116 (i.e. image plane 330), thereby obtaining a raw image having information from different views. The raw image may be processed by the image processing unit 120 to obtain the view sub-images 340, 350 and 360, as illustrated in FIG. 3B, wherein the view sub-image 350 can be regarded as a center view image. It should be noted that since view sub-images 340, 350 and 360 are images captured from different views in the object space 310, the horizontal locations (i.e. and/or vertical locations) of the objects 301˜303 in the view sub-images 340˜360 may vary due to different view angles, as illustrated FIG. 3B. Specifically, when the image processing unit 120 performs a digital focusing process on the view sub-images 340˜360, the image processing unit 120 may overlap the view sub-images 340 and 350 together, thereby obtaining a refocused view image 370, as illustrated in FIG. 3C. Note that only the object 302 is completely overlapped in the refocused view image 370 in FIG. 3C. Due to different view angles being used, the locations of the objects 301 and 303 in the view sub-images 340 and 350 may be different, respectively.

Further, the objects 301˜303 are located at different depths from the primary lens 112. When one of the objects (e.g. the object 302) is digitally refocused, only pixels having the same depth with the refocused object are clear. Other pixels at different depths may be slightly blurred since the view sub-images from different views are overlapped. In addition, the image processing unit 120 may overlap the view sub-images 350 and 360 together to obtain a refocused image, or overlap all the view sub-images 340˜360 together to retrieve another refocused image (not shown). That is, the image processing unit 120 only focuses on the object 302 in the embodiment. The image processing unit 120 may further perform interpolation to different view sub-images to obtain refocused images or corresponding different view sub-images with an increased amount of pixels.

In another embodiment, if the image processing unit 120 performs focusing on the object 303, the image processing unit 120 may regard the view sub-image 350 as a reference image, and perform a shifting process to the view sub-image 340 in a horizontal direction and/or vertical direction relative to the view sub-image 350, thereby completely overlapping the object 303 with both the view sub-images 340 and 350 to obtain a refocused view image 380, as illustrated in FIG. 3D. Similarly, the image processing unit 120 may also overlap the view sub-images 350 and 360, or overlap all the view sub-images 340˜360 together to obtain another refocused view image (not shown). That is, the image processing unit 120 only focuses on the object 303 in the embodiment. The image processing unit 120 may further perform interpolation to different view sub-images to obtain refocused images or corresponding different view sub-images with an increased amount of pixels. In yet another embodiment, if the image processing unit 120 performs focusing on the object 301, similar methods described in the aforementioned embodiments can be used. That is, the view sub-image 350 may be regarded as a reference image, and other view sub-images can be shifted relative to the view sub-image 350, so that the object 301 is completely overlapped with each view sub-image to generate a refocused view image 390, as illustrated in FIG. 3E. In the aforementioned embodiments of FIGS. 3A˜3E, it is appreciated that the refocusing process executed by the image processing unit 120 may be the image processing unit 120 performing a shifting and addition process to the view sub-images around a specific view sub-image to obtain the refocused view image.

It should be noted that, the aforementioned shifting and addition process may regard an object (e.g. the object 302 in FIG. 3B) as a reference, and different view sub-images are shifted, so that the object is completely overlapped with each view sub-image. Then, the portions other than the object (e.g. objects 301 and 303 in FIG. 3B) in each view sub-image are added, and thus the added portions may be slightly blurred. For example, the object 302 is regarded as a reference in FIG. 3C, and thus only the object 302 is clear in the refocused view image 370. Similarly, the object 303 is regarded as a reference in FIG. 3D, and thus only the object 303 is clear in the refocused view image 380. The object 301 is regarded as a reference in FIG. 3E, and thus only the object 301 is clear in the refocused view image 390.

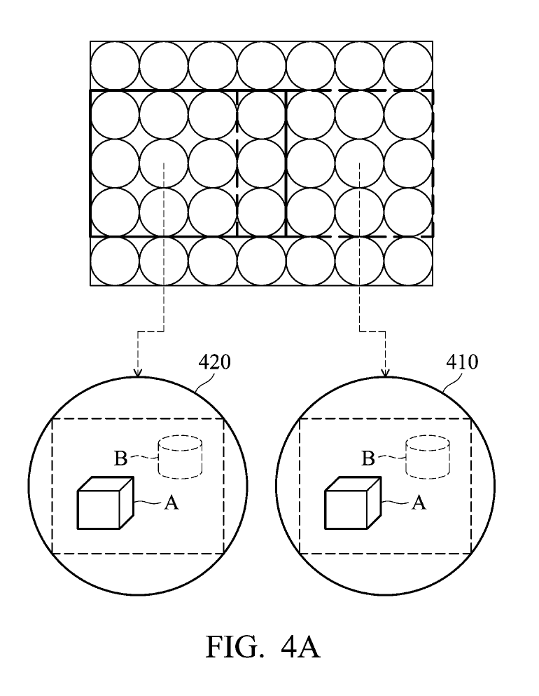

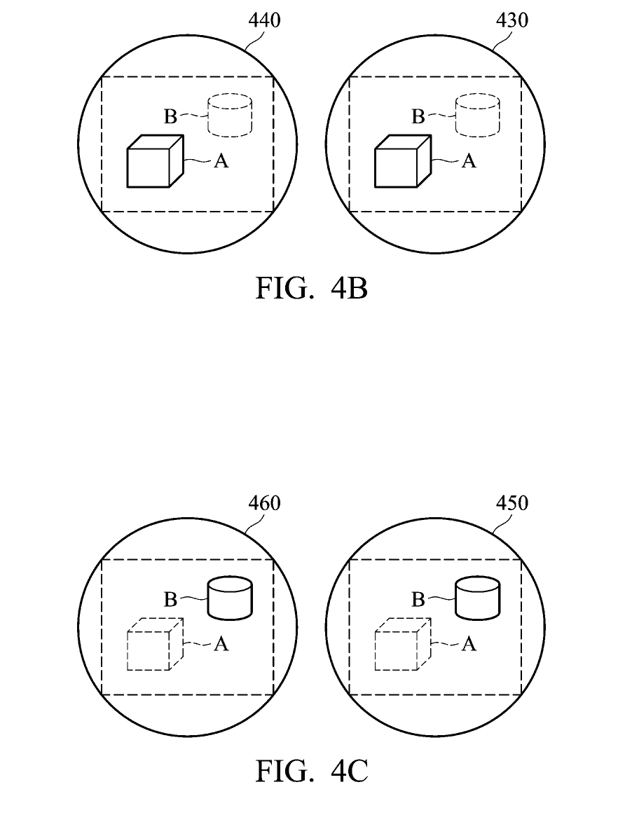

FIGS. 4A˜4C are diagrams illustrating stereoscopic displaying of the image processing unit 120 according to the first embodiment of the disclosure. Referring to the embodiment of FIG. 2, when the image processing unit 120 outputs images to the stereoscopic display device, appropriate processes should be done to the different view images for stereoscopic displaying (e.g. left view image and right view image) in advance. For example, the image processing unit 120 may rearrange the raw image, which has information from different views, from the image capturing unit 110 to different view sub-images (e.g. view sub-images 410 and 420). As illustrated in FIG. 4A, when the image processing unit 120 takes the view sub-image 410 as a reference image for calculating the right view image, the image processing unit 120 may set a region (e.g. 4×3 different view sub-images up/down/left/right to the view sub-image 410), and perform a digital focusing process to the view sub-images in the region to generate the right view image. Reference can be made to the embodiments of FIGS. 3A˜3E, for the details of the aforementioned procedure. Similarly, when the image processing unit 120 is calculating the appropriate parallax required for a stereoscopic image, the view sub-image 420 can be taken as a reference image for calculating the left view image. Meanwhile, the image processing unit 120 may set another region (e.g. 4×3 different view sub-images left/right to the view sub-images 420), and perform a digital focusing process to the view sub-images in the region to generate the left view image. Reference can be made to the embodiments of FIGS. 3A˜3E, for the details of the digital focusing process.

In addition, the image processing unit 120 may receive an external control signal (e.g. from the stereoscopic display device, the image capturing device, or other devices, such as a personal computer) for refocusing on an object at different depths. For example, the image capturing unit 110 may focus on the object A in the beginning, and thus the left view image 440 and the right view image 430 to be generated by the image processing unit 120 may focus on the object A, as illustrated in FIG. 4B. When the image processing unit 120 receives an external control signal to perform a digital refocusing process, the output left view image 460 and the right view image 450 may refocus on the object B, as illustrated in FIG. 4C.

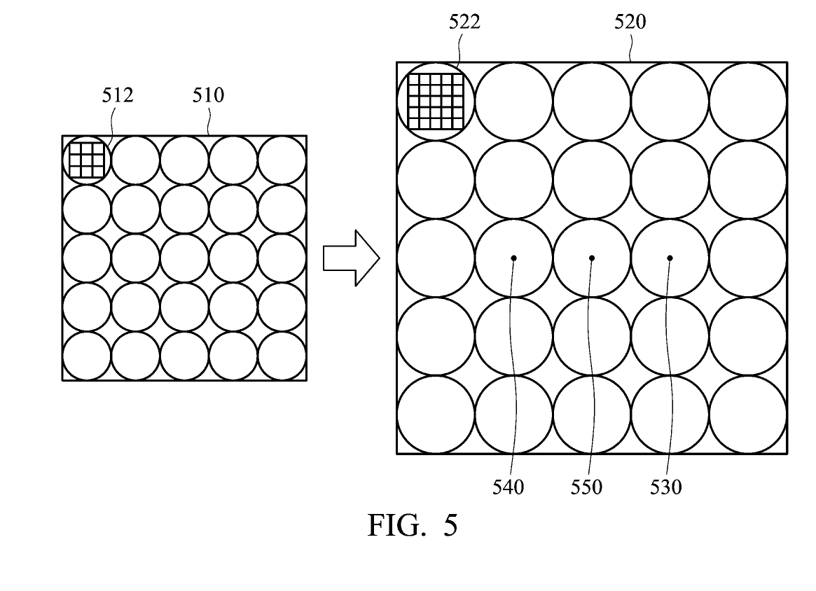

FIG. 5 is a diagram illustrating the image enlarging process of the raw image having information from different views according to the second embodiment of the disclosure. The differences between the embodiment in FIG. 5 and that of FIGS. 4A˜4C may be that the raw image in FIG. 5 may be pre-processed by the image processing unit 120, such as performing a scaling process to the raw image, so that the amount of pixels in the scaled raw image may become larger or smaller in comparison with that of the raw image before the scaling process. Thus, the resolution of the generated left view image and the right view image may match the required input image resolution of the stereoscopic display device, wherein well-known image scaling techniques (e.g. bilinear interpolation or bi-cubic interpolation) can be used in the aforementioned scaling process to perform pixel interpolation or extrapolation. For example, as illustrated in FIG. 5, the image processing unit 120 may enlarge the view sub-image set 510 in the horizontal direction and vertical direction by 1.67 times that of the height and width of each view sub-image to generate an enlarged image 520. Given that there are 3×3 pixels in the image sub-set 512 of the view sub-image set 510, the image sub-set 522 in the corresponding location of the enlarged image 520 may comprise 5×5 pixels. It should be noted that the aforementioned embodiment merely describes the enlarging process of an image sub-set in the corresponding location. For those skilled in the art, it is appreciated that the aforementioned enlarging process can be also applied to other image sub-sets at other corresponding locations, and the image enlarging ratio can be adjusted freely. Subsequently, the image processing unit 120 may select a respective view sub-image (e.g. view sub-images 530 and 540) from the enlarged image 520 as a reference image for the left view image and the right view image, and perform a digital focusing process to the different view sub-images within a region of the two reference images, thereby generating the refocused left view image and the refocused right view image. Reference can be made to the embodiments of FIGS. 3A˜3E, for the details of the digital focusing process.

In the embodiment, after the image processing unit 120 enlarges the view sub-image set 510 in the horizontal direction and vertical direction by 1.67 times that of the width and height of each view sub-image to generate the enlarged image 520, the image processing unit 120 may further covert the enlarged image 520 into a corresponding format based on the display requirement of the stereoscopic display device (e.g. multi view sub-images in three views or more, such as the view sub-images 530˜550, and the corresponding image format). Then, the image processing unit 120 may perform the digital refocusing process to the converted enlarged image according to the received external control signal, and output multiple view images generated by the digital refocusing process to the stereoscopic display device.

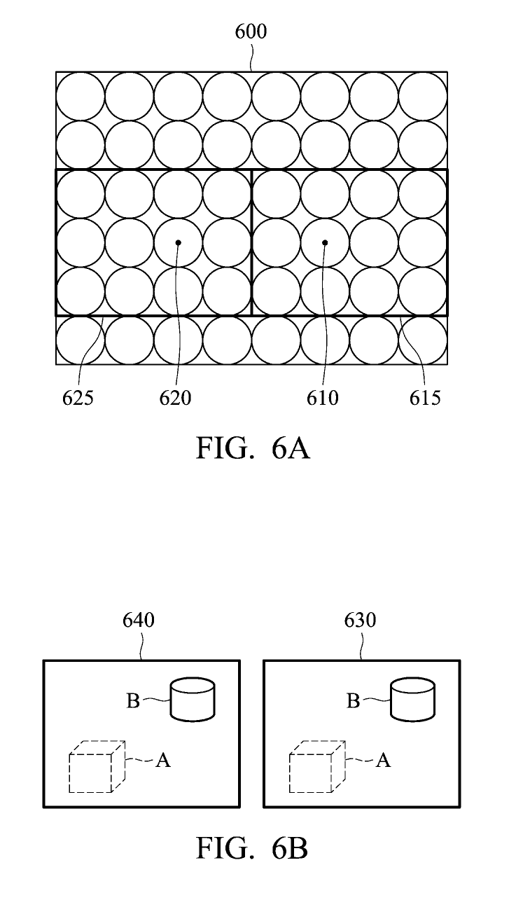

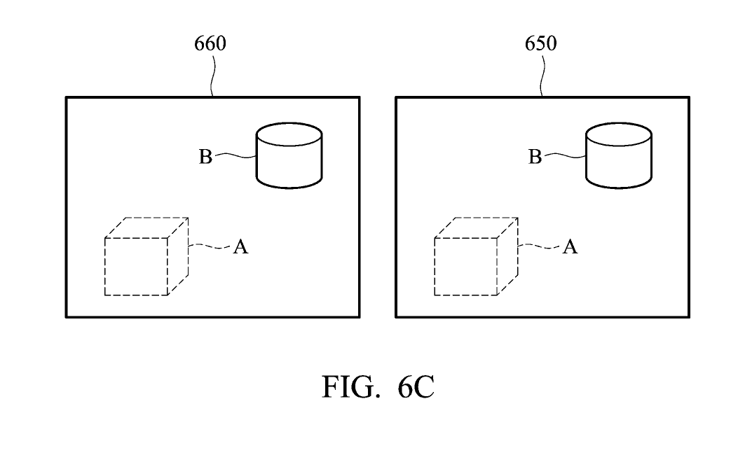

FIGS. 6A˜6C are diagrams illustrating stereoscopic displaying of the image processing unit according to the third embodiment of the disclosure. Referring to FIGS. 2 and 6A˜6C, for example, the image processing unit 120 may determine the view sub-images 620 and 610 from the view sub-image set 600 as reference images for the left view image and the right view image, respectively, as illustrated in FIG. 6A. Then, the image processing unit 120 may perform a digital focusing process to the view sub-images within the regions 625 and 615 to generate the left view image 640 and the right view image 630 (i.e. the refocused view images), as illustrated in FIG. 6B. However, it is possible that the resolution of the left view image 640 and the right view image 630 does not match the resolution requirement of the stereoscopic display device, and thus the image processing unit 120 may further perform a scaling process on the left view image 640 and the right view image 630 (e.g. enlarging the left/right view images in the horizontal direction and vertical direction for 1.5 times), thereby generating a left view image 660 and right view image 650 which having a resolution matching with the requirement of the stereoscopic display device, as illustrated in FIG. 6C. Then, the image processing unit 120 may output the left view image 660 and the right view image 650 to the stereoscopic display device. It should be noted that the image capturing unit 110 focuses on the object A in the beginning. After the image processing unit 120 has received an external control signal (e.g. from the stereoscopic display device), the image processing unit 120 may adjust the output left/right view images for focusing on the object B.

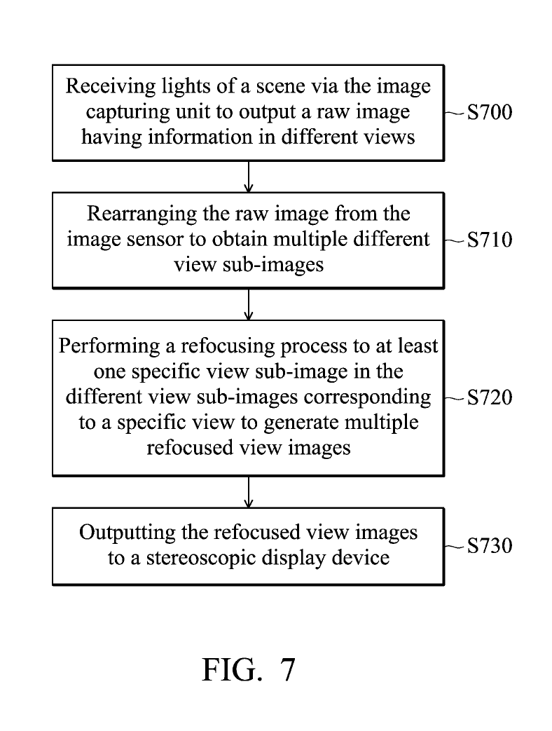

FIG. 7 is a flow chart illustrating the image refocusing method according to an embodiment of the disclosure. In step S700, the image capturing unit 110 may receive lights from a scene, and output a raw image having information from different views. For example, the lights from the scenes may pass through the primary lens 112 and the lens array of the image capturing unit 110, and form the raw image on the image sensor 116. In step S710, the image processing unit 120 may rearrange the raw image from the image capturing unit 110 to obtain multiple different view sub-images. In step S720, the image processing unit 120 may perform a digital refocusing process to at least one specific view sub-image having a specific view corresponding to the multiple different view sub-images to generate multiple refocused view images. In step S730, the image processing unit 120 may output the multiple refocused view images to a stereoscopic display device.

It should be noted that the aforementioned embodiments in FIGS. 5 and 6A˜6C can be combined into the method described in FIG. 7. For example, as described in the embodiment of FIG. 5, after step S710, the image processing unit 120 may perform a scaling process on the different view sub-images to generate enlarged images which match the resolution requirement of the stereoscopic display device. Then, the image processing unit 120 may determine a reference image for the left view image and the right view image from the enlarged image, respectively. The image processing unit 120 may perform a digital focusing process to the different view sub-images within a predetermined range to generate the refocused left view image and the refocused view right image. In addition, in the aforementioned embodiment, after the image processing unit 120 performs the scaling process to the different view sub-images, the image processing unit 120 may further convert the enlarged images to match the requirement of the stereoscopic display device (e.g. view sub-images in three views or more, and a corresponding image format), and then perform a digital refocusing process to the converted enlarged images. That is, the image processing unit 120 may generate a specific amount of different view sub-images and a corresponding image format required in the stereoscopic display device by using the enlarged different view sub-images. Further, as described in the embodiments of FIGS. 6A˜6C, it is possible that the generated refocused view images do not match the resolution requirement of the stereoscopic display device. Accordingly, the image processing unit 120 may perform a scaling process on the refocused view images to generate a left view image and a right view image that matches the resolution requirement of the stereoscopic display device.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image processing apparatus, comprising
an image capturing unit, comprising:
a primary lens;
a lens array comprising multiple sub-lenses arranged in a direction perpendicular to a light axis of the primary lens; and
an image sensor configured to receive lights of a scene passing through the primary lens and the lens array, and output a raw image having information of different views; and
an image processing unit configured to rearrange the raw image from the image sensor to obtain multiple different view sub-images, and perform a refocusing process to at least one specific view sub-image of the different view sub-images corresponding to a specific view to generate multiple refocused view images, wherein a first focusing position of the refocused view images is different from a second focusing position of the at least one specific view sub-image,
wherein the processing unit further outputs the refocused view images to a stereoscopic display device.

2. The image processing apparatus as claimed in claim 1, wherein the refocusing process is the image processing unit performing a shifting and addition process to the view sub-images around the at least one specific view sub-image, thereby adjusting the second focusing position of the specific view sub-image.

3. The image processing apparatus as claimed in claim 1, wherein after obtaining the different view sub-images, the image processing unit further performs a scaling process to the different view sub-images to match a resolution requirement of the stereoscopic display device.

4. The image processing apparatus as claimed in claim 3, wherein after performing the scaling process to the different view sub-images, the image processing unit further generates a specific amount of the different view sub-images and a corresponding image format required in the stereoscopic display device by using the scaled different view sub-images.

5. The image processing apparatus as claimed in claim 1, wherein after generating the refocused view images, the image processing unit further performs a scaling process to the refocused image to match a resolution requirement of the stereoscopic display device, and outputs the scaled refocused view images to the stereoscopic display device.

6. An image refocusing method for use in an image processing apparatus, wherein the image processing apparatus comprises an image capturing unit and an image processing unit, the image refocusing method comprising:
receiving lights of a scene via the image capturing unit to output a raw image having information of different views;
rearranging the raw image from an image sensor to obtain multiple different view sub-images;
performing a refocusing process to at least one specific view sub-image of the different view sub-images corresponding to a specific view to generate multiple refocused view images, wherein a first focusing position of the refocused view images is different from a second focusing position of the at least one specific view sub-image; and
outputting the refocused view images to a stereoscopic display device.

7. The image refocusing method as claimed in claim 6, wherein the refocusing process comprises:
performing a shifting and addition process to the view sub-images around the at least one specific view sub-image, thereby adjusting the second focusing position of the specific view sub-image.

8. The image refocusing method as claimed in claim 6, wherein after obtaining the different view sub-images, the method further comprises:
performing a scaling process to the different view sub-images to match a resolution requirement of the stereoscopic display device.

9. The image refocusing method as claimed in claim 8, wherein after performing the scaling process to the different view sub-images, the method further comprises:
generating a specific amount of the different view sub-images and a corresponding image format required in the stereoscopic display device by using the scaled different view sub-images.

10. The image refocusing method as claimed in claim 6, wherein after generating the refocused view images, the method further comprises:
performing a scaling process to the refocused image to match a resolution requirement of the stereoscopic display device; and
outputting the scaled refocused view images to the stereoscopic display device.
